(19) United States
(12) Patent Application Publication
(10) Pub. No.: US 2017/0081079 A1
(43) Pub. Date: Mar. 23, 2017

(54) STRETCHED-BLOW MOLDED CONTAINER HAVING AN INTEGRALLY MOLDED DEEP GRIP AND PROCESS FOR MAKING SAID CONTAINER

(71) Applicant: PLASTIPAK BAWT S.À R.L., Bascharage (LU)

(72) Inventors: Sam Van Dijck, Hoogstraten (BE); Alain Dessaint, Kampenhout (BE); Natalia Matthieu, Antwerpen (BE)

(21) Appl. No.: 15/039,289

(22) PCT Filed: Nov. 25, 2014
(86) PCT No.: PCT/EP2014/075521

§ 371 Date: May 25, 2016

(30) Foreign Application Priority Data
Nov. 26, 2013 (EP) 13194483.7

(51) Int. Cl. B65D 23/10; B65D 1/02; B65D 79/00; B29C 49/08

(52) U.S. Cl. CPC B65D 23/102; B29C 49/08; B65D 1/0246; B65D 79/005; B29L 2031/7158

(57) ABSTRACT

The intermediate stretched-blow molded container (1) comprises a biaxially stretched-blow molded hollow body (10) that comprises a container side wall (10a), at least one recess (101) that is formed in said container side wall (10a), that is off-center from the second vertical central plane (P2), and at least one convex and outwardly protruding deformable region (102) that is formed in the container side wall (10a). The maximum gripping dimension (DR) of the stretched-blow molded hollow body (10) measured next to and on one side of the convex and outwardly protruding deformable region (102) is smaller than the maximum dimension (DL) of the stretched-blow molded hollow body (10) measured next to and on the other side of convex and outwardly protruding deformable region (102). Said convex and outwardly protruding deformable region (102) comprises an outwardly protruding invertable lateral wall (1020) that is an extension of a second lateral wall (1011) of the recess (101) and that extends beyond a first lateral wall (1010) of the recess (101), and a front wall (1021) that is an extension of this outwardly protruding invertable lateral wall (1020). The junction (H) between the bottom portion (1012) and the second lateral wall (1011) of said recess (101) forms an hinge on the whole periphery of the outwardly protruding convex deformable region (102) for inverting the said outwardly protruding convex deformable region ((102) and the second lateral wall (1011) of the recess (101) by pushing them inwardly in order to form a concave grip (G).

### TECHNICAL FIELD

The present invention relates to the field of stretched-blow molded containers having an integrally molded deep grip, preferably with good ergonomics for large containers.

### PRIOR ART

Processes for making stretched-blow molded containers, and in particular injection stretched-blow molded (ISBM) containers, having an integrally molded deep handgrip have already been disclosed in PCT applications WO 00/59790 and WO 2006/113428, and in European patent application EP 2 103 413.

According to said known processes, in a first blow molding step a first intermediate stretched-blow molded container is formed by stretch-blow molding a preform in a blow mold cavity to form an intermediate container comprising opposite “ears” or “bubbles” forming convex deformable regions. Then in a second boxing step carried out either in the same blow mold cavity or in a specific boxing mould, each deformable region of the intermediate container is mechanically pushed inwardly, preferably while maintaining a certain pressure inside the container, to invert the deformable region and form a molded hand grip in a final container.

The boxing step can be carried out when the temperature of the first intermediate stretched-blow molded container is below (“cold boxing”) the glass transition temperature (Tg) of the polymer constituting the container, or when the temperature of the first intermediate stretched-blow molded container is above (“hot boxing”) said glass transition temperature (Tg) as disclosed in EP 2 103 413.

The deformable convex regions of the intermediate container described In PCT application WO 00/59790 and shown on the drawings thereof are formed in two flat and opposite parallel vertical walls of the intermediate container, which limits the container size and volume for an ergonomic gripping.

In PCT application WO 2006/113428, the container side wall is designed in order to advantageously form a hand gripping region of smaller dimensions, and the deformable convex regions are formed in curved portions of the container side wall, which advantageously enables to make a container of large volume that is easier to grip. But the depth of the concave regions forming the molded hand grip after inward deformation of the deformable convex regions of the intermediate container is limited, and the solution disclosed in said PCT application WO 2006/113428 does not enable to make ISBM containers of large volume having a molded hand grip that is sufficiently deep for an ergonomic gripping of the container.

In European patent application EP 2 103 413, the outward “bubbles” forming the deformable convex regions can be inverted only by carrying out a hot boxing step, i.e. when the temperature of the first intermediate stretched-blow molded container is above the glass transition temperature (Tg) of the polymer constituting the container, and are not suitable for carrying out a cold boxing step.

### Objective of the Invention

An objective of the invention is to propose a novel solution for making a stretched-blow molded containers having an integrally molded deep grip, said solution overcoming the drawbacks of the aforesaid solutions of the prior art.

### SUMMARY OF THE INVENTION

A first object of the invention is a process, as defined in claim 1, for making a stretched-blow molded container with at least one concave deep grip with an undercut region.

A second object of the invention is an intermediate stretched-blow molded container as defined in claim 31.

A second object of the invention is a process, as defined in claim 53, for making a-stretched-blow molded container with least one concave grip.

A third object of the invention is an ISBM container with least one concave grip as defined in claim 60.

### BRIEF DESCRIPTION OF THE DRAWINGS

Other technical characteristics and advantages of the invention will appear more clearly on reading the following detailed description which is made by way of non-exhaustive and non-limiting example, and with reference to the appended drawings, as follows:

FIG. 1 is a side view of an example of an intermediate stretched blow-molded container of the invention.

FIG. 2 is schematic side view of a blow mold cavity containing the intermediate stretched blow-molded container of FIG. 1.

FIG. 3 is a view in cross section of FIG. 2 in plane III-Ill.

FIG. 4 is a side view of an example of the final stretched blow-molded container obtained from the intermediate stretched blow-molded container of FIG. 1.

FIGS. 5 to 15 are views in cross section of the final stretched blow-molded container of FIG. 4 respectively in horizontal cross section planes V-V, VI-VI, VII-VII, VIII-VIII, IX-IX, X-X, XI-XI, XII-XII, XIII-XIII, XIV-XIV, XV-XV, said views showing in dotted lines the convex and outwardly protruding deformable region of the intermediate stretched blow-molded container of FIG. 1.

FIG. 16 is a view in cross section of the final stretched blow-molded container of FIG. 4 in cross section plane XVI-XVI.

FIG. 17 is an enhanced detail of FIG. 10.

FIG. 18 is another example of profile for the bottom portion of the recess of an intermediate stretched blow-molded container of the invention.

FIGS. 19 to 25 are other examples of horizontal cross section of a final stretched blow-molded container of the invention, the convex and outwardly protruding deformable region of the corresponding intermediate stretched blow-molded container being represented in dotted lines.

### DETAILED DESCRIPTION

Some preferred embodiments of the invention are discussed in detail below. While specific exemplary embodiments are discussed, it should be understood that this is done for illustration purpose only. A person skilled in the art will recognize that other container designs or container dimensions can be used without parting from the spirit and scope of the invention.

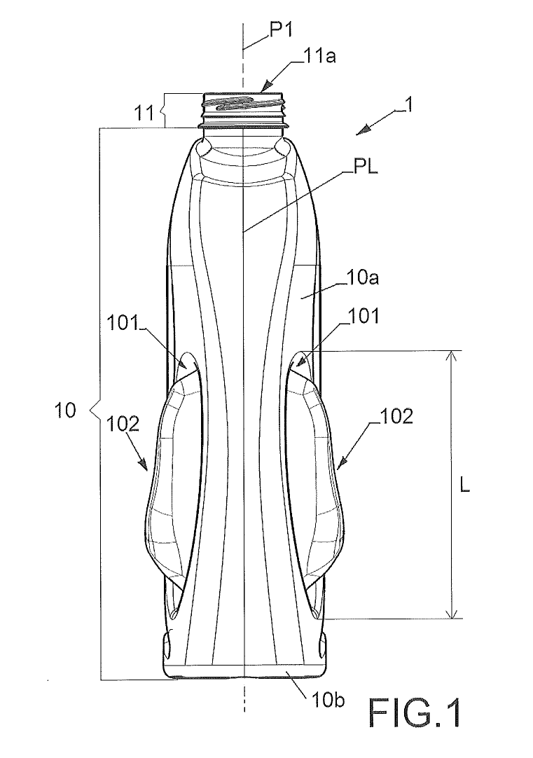

Referring now to the drawings, FIG. 1 illustrates an intermediate plastic container 1 having a biaxially stretched blow-molded hollow body 10, and a cylindrical neck finish 11 comprising a top pouring opening 11a. The biaxially stretched blow-molded hollow body 10 comprises a vertical side wall 10a extended by a bottom wall 10b forming the base of the container.

Within the scope of the invention, the intermediate plastic container 1 can be made of any thermoplastic material that can be processed by using injection stretched bow molded techniques. Preferred thermoplastic materials useful for the invention are polyesters, and in particular polyethylene terephthalate (PET), homo or copolymers thereof, and blend thereof. Other materials suitable for use in the present invention are polypropylene (PP), polyethylene (PE), polystyrene (PS), polyvinyl chloride (PVC) and polylactic acid (PLA), homo or copolymers thereof, and blend thereof.

Although the containers shown in the appended drawings are monolayer containers, the invention is however not limited to monolayer containers but encompasses also multilayer containers.

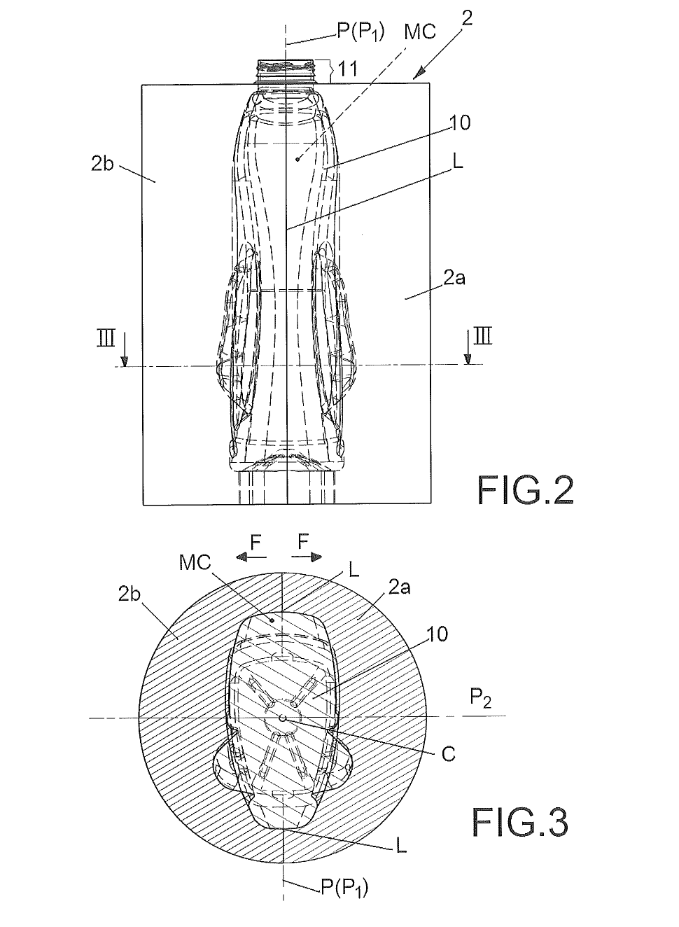

A well-known injection stretched blow molding technique can be used for making the intermediate plastic container 1. In particular, a small tubular plastic preform having the same neck finish 11 than the intermediate container 1 is knowingly injected in a mould. In reference to FIGS. 2 and 3, this preform is subsequently biaxially stretched in a mold cavity MC of a blow mold 2 in order to form the intermediate container 1. During this blow molding step, the neck finish 11 is not stretched and only the body of the preform below the neck finish 11 is biaxially stretched in the mold cavity MC, in order to form the stretched blow-molded hollow body 10 of the container 1.

Within the scope of the invention a “one stage process” or a “two stages process” can be carried out. In the one stage process”, the stretch-blow molding step of the preform is performed in line immediately after the first injection step (preform injection). In the “two stages process”, the stretch-blow molding step of the preform in the blow mold cavity is postponed, and a reheating of the preform is performed prior to this stretch-blow molding step.

The blow mold 2 knowingly comprises two halves 2a, 2b that define a contact plane P when the mold is closed as depicted on FIG. 3. These two mold halves 2a, 2b can be moved away from each other in a direction perpendicular to plane P (arrows F of FIG. 3) in order to open the mold cavity MC and remove the container from the mold cavity MC.

The outer surface of the stretched blow-molded hollow body 10 of the intermediate container 1 comprises two visible and thin molding lines PL (FIG. 1), commonly referred as “parting lines”. These parting lines PL are formed at each vertical intersection line L (FIG. 3) between the two mold halves 2a, 2b and the stretched blow molded hollow body 10. On FIG. 1, only one parting line PL is visible, the other opposite parting line PL being hidden and located on the opposite face of the container 1. These parting lines PL define for the intermediate container 1 a first main central vertical plane P1 that includes these parting lines PL. This first main central vertical plane P1 corresponds to aforesaid contact plane P when the container 1 is in the closed mold cavity (FIG. 3).

As depicted on the appended figures, the intermediate container 1 also comprises a second vertical central plane P2 perpendicular to the first vertical central plane P1. The vertical axis C at the intersection between the first P1 and second P2 central planes is the vertical central axis of the stretched blow-molded hollow body 10 of the intermediate container 1.

In the particular example of FIG. 1, this central axis C is also the central axis of the cylindrical neck finish 11. In other variants within the scope of the invention, the central axis of the cylindrical neck finish 11 is not necessarily the same than the vertical central axis C of the stretched blow-molded hollow body 10, but can be offset from said vertical central axis C. The central axis of the cylindrical neck finish 11 is also not necessarily parallel to the vertical central axis C of the stretched blow-molded hollow body 10, and the neck finish is not necessarily cylindrical.

In reference to FIG. 1, the stretched-blow molded hollow body 10 of container 1 comprises two opposite recesses 101 that are formed in the side wall 10a of the container 1. Each recess 101 defines a closed contour and is off-center from the second vertical central plane P2. The stretched-blow molded hollow body 10 of container 1 also comprises two opposite convex and outwardly protruding deformable regions 102 that are formed in the container side wall 10a. Each convex and outwardly protruding deformable region 102 is surrounded by one recess 101.

In reference to FIG. 1, each recess 101 forms an elongated closed contour of maximum vertical length L (maximum dimension of the recess 101 measured in a direction parallel to the central axis C of the container) and of maximum horizontal width W (dimension of the recess 101 measured in a direction perpendicular to the central axis C of the container). Within the scope of the invention, the recess 101 can form a closed contour of any shape, and can form a closed contour that is for example circular or rectangular. The recess 101 does not necessarily defined closed contour that would surround the convex and outwardly protruding deformable regions 102 on the whole periphery thereof, but the recess 101 in another variant, the recess 101 can also extend only on a portion of the periphery of the convex and outwardly protruding deformable regions 102.

In the particular embodiment of the appended figures, the two recesses 101 are identical and are symmetrical, and the two convex and outwardly protruding deformable regions 102 are also identical and are symmetrical, the central plane P1 forming a mirror symmetry plane for the recesses 101 and the convex and outwardly protruding deformable regions 102. Within the scope of the invention, in other embodiments of the invention, the two opposite recesses 101 are neither necessarily identical nor symmetrical, and the two opposite convex and outwardly protruding deformable regions 102 are neither necessarily identical nor symmetrical. The intermediate container 1 can also have only one recess 101 and one convex and outwardly protruding deformable regions 102 surrounded by said recess 101.

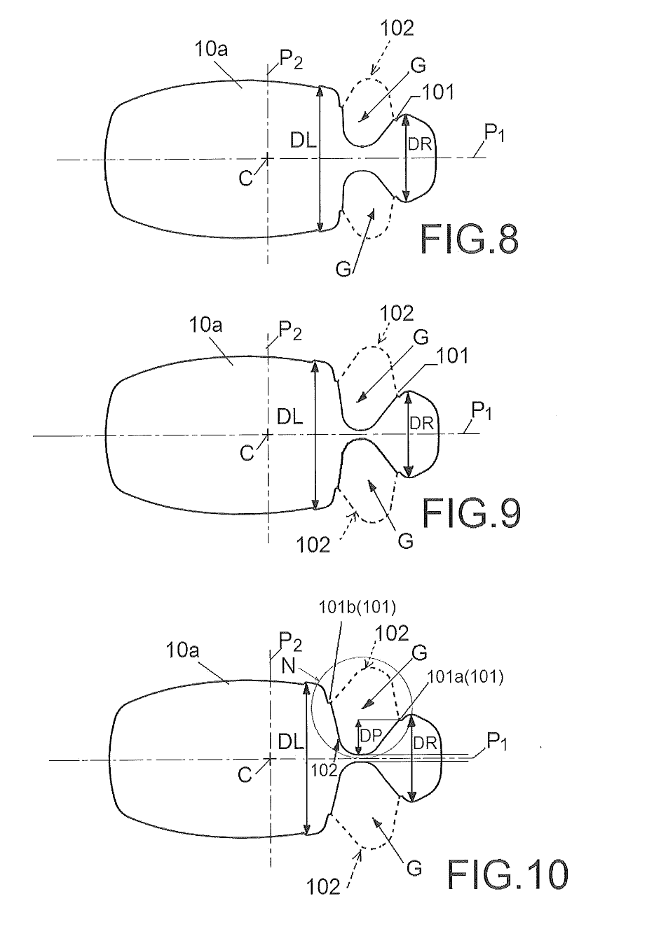

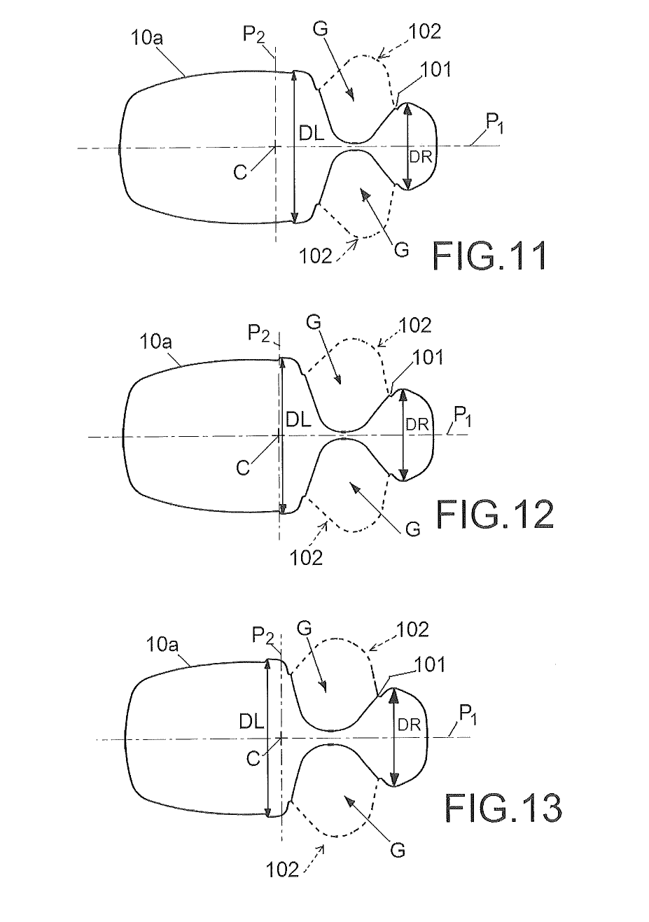

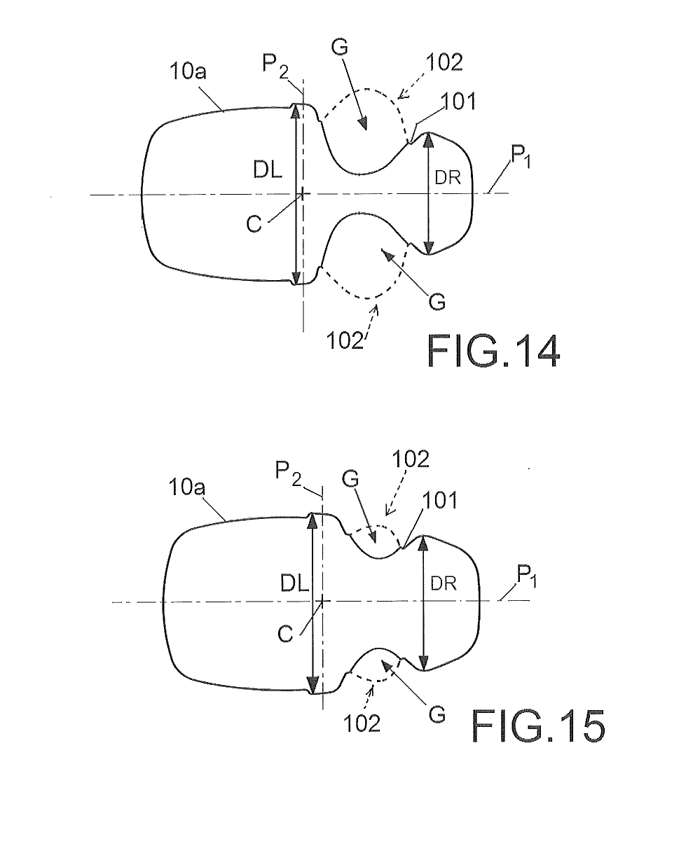

In reference to FIGS. 7 to 15, dimension DR is the maximum dimension of the stretched-blow molded hollow body 10 measured in a gripping region of the container side wall 10a next to and on one side of each convex and outwardly protruding deformable region 102, in an horizontal cross section plane, that is perpendicular to the said first P1 and second P2 central vertical planes, and that is intersecting the recess 101, and in a direction perpendicular to the first vertical plane P1. Dimension DL is the maximum dimension of the stretched-blow molded hollow body 10a measured next to and on the other side of each convex and outwardly protruding deformable region 102 in the same cross section plane and direction than dimension DR. In the invention dimension DR is smaller than dimension DL, in order to form in the container side wall 10a a gripping region that is more ergonomic. In particular, for an ergonomic gripping, dimension DR will be preferably between 30 mm and 70 mm, and preferably between 40 mm and 60 mm.

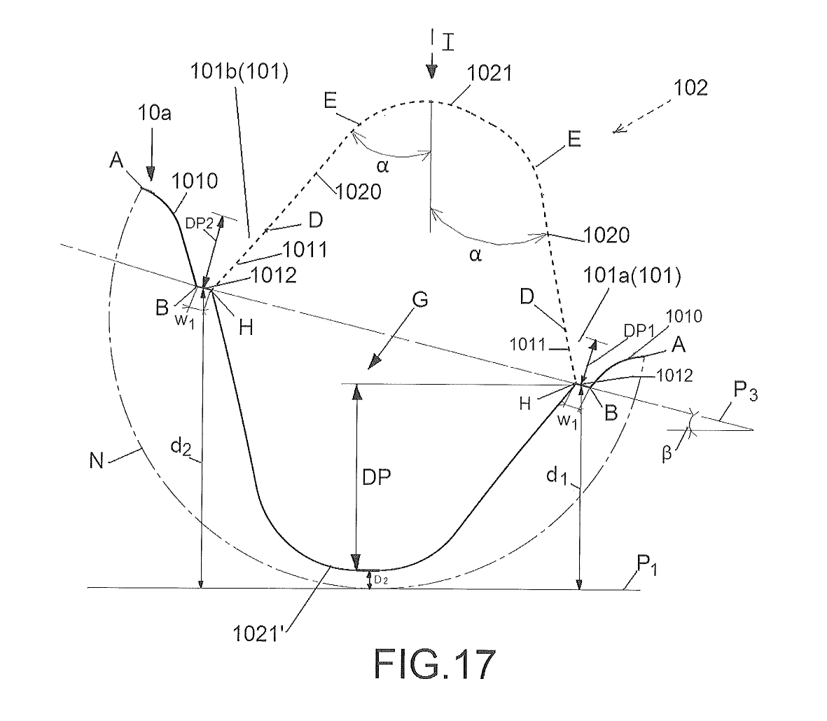

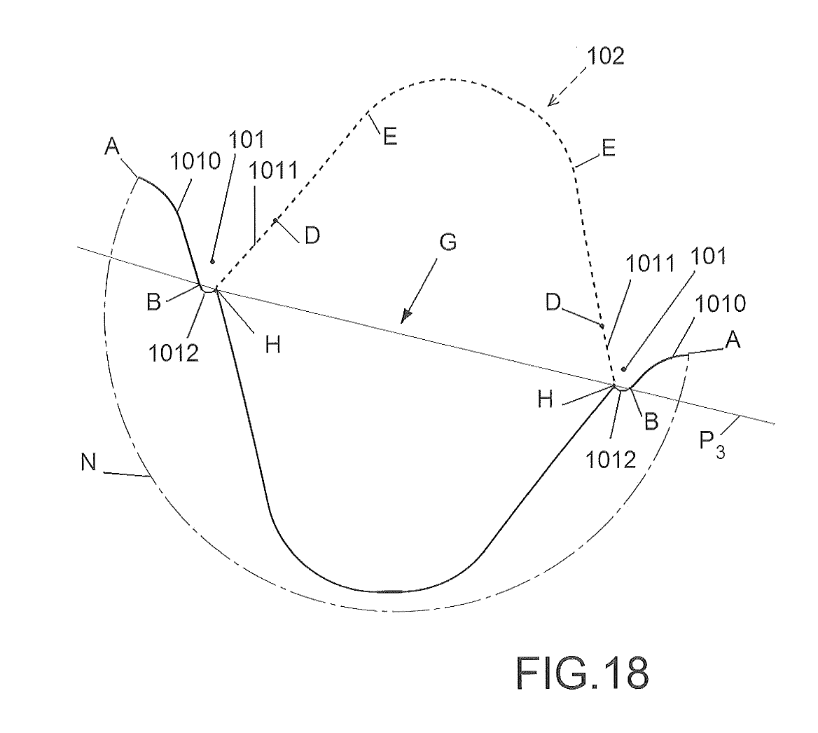

In reference to FIG. 17, each recess 101 comprises a first 1010 lateral wall extending between A and B, a second opposite lateral wall 1011 extending between H and D, and a bottom portion 1012 extending between B and H, and joining said first lateral wall 1010 to said second lateral wall 1011. In the particular embodiment of FIG. 17, the bottom portion 1012 is a flat wall of small width W1, for example between 1 mm and 2 mm. In another variant, the bottom portion 1012 can be also a small concave arc-shaped portion 1012 having a small radius of curvature as shown on the variant of FIG. 18.

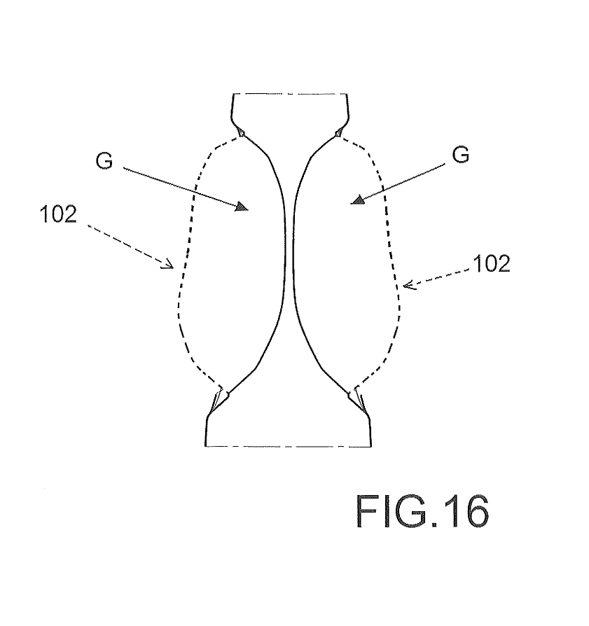

More particularly, said first 101) and a second opposite 1011 lateral walls of said recess 101 are flat or smoothly curved without any hinge region. Referring to FIGS. 7 to 18, each convex and outwardly protruding deformable region 102, before inversion thereof, is represented in dotted lines. Each convex and outwardly protruding deformable region 102 comprises an invertable lateral wall 1020 (FIG. 17/between D and E) and a convex front wall 1021 (FIG. 17/between E and E) that is an extension of this invertable lateral wall 1020. Said invertable lateral wall 1020 is an outward extension of said second lateral wall 1011 of the recess 101 and extends outwardly beyond the first lateral wall 1010 of the recess 101.

More particularly, the orthogonal projection on the first central plane P1 of each outwardly protruding deformable region 102 is located within the container.

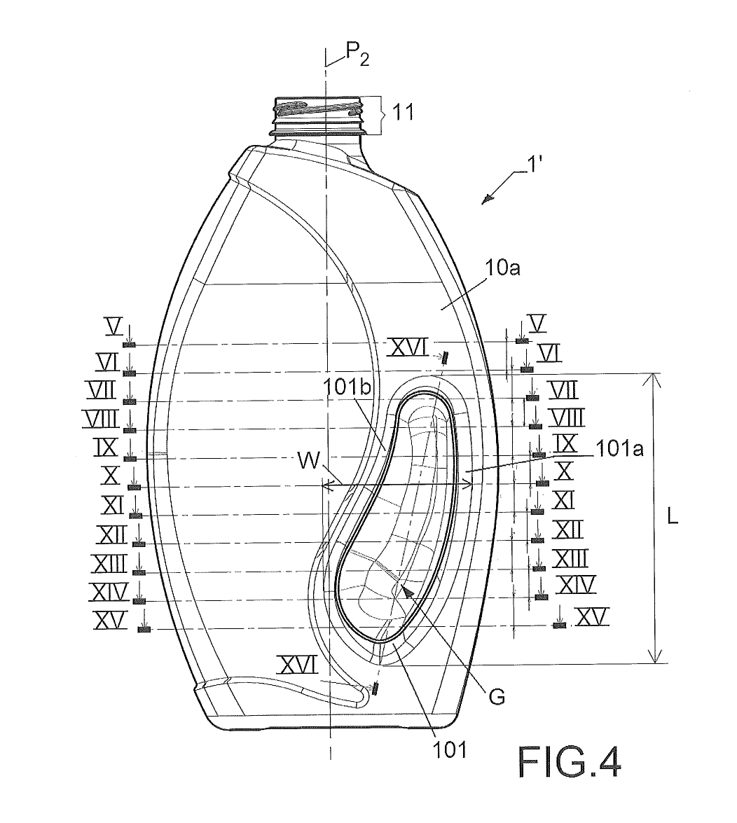

On the whole periphery of the convex and outwardly protruding deformable region 102, the junction H between the bottom portion 1012 and the second lateral wall 1011 of each recess 101 forms an hinge that can be used for mechanically inverting said convex and outwardly protruding deformable region 102 and the second lateral wall 1011 of the recess 101 by pushing them inwardly in order to form an ergonomic and integrally molded deep handgrip G. The final container 1′ of FIG. 4 is thus obtained by pushing inwardly, towards the first vertical central plane P1, each convex and outwardly protruding deformable region 102 and each second lateral wall 1011 of the recess 101 in such a way to mechanically invert them and form the ergonomic and integrally molded deep handgrip G.

In reference to FIG. 17, once the convex and outwardly protruding deformable region 102 (in dotted lines) and the second lateral wall 1011 of the recess 101 have been mechanically inverted, it forms a concave grip region G, that is substantially the mirror image of the convex and outwardly protruding deformable region 102 and of the second lateral wall 1011 of the recess 101 with respect to a symmetry plane P3 that is tangential to aforesaid hinge H.

Said mechanical inversion is performed in a boxing step subsequently to the aforesaid first blow molding step. This boxing step can be carried out either in the blow mould cavity MC that has been used for making the intermediate stretched blow-molded container 1 or in a different and specific boxing mold. The boxing step is carried out by moving inwardly a moveable plug in the mould in contact with the front wall 1021 of the convex and outwardly protruding deformable region 102, while the inside of the intermediate stretched blow-molded container 1 is preferably filled with air under a certain pressure for maintaining an internal pressure inside the container, for example a pressure of about 20 bars. The mechanical force exerted by the moving plug onto the front wall 1021 of the convex deformable region 102 (see FIG. 17/arrow I) is for example, but not necessarily, perpendicular to central plane P1. It can be exerted by a translational movement and/or a rotational movement of a plug actuated by a hydraulic, electric or pneumatic jack. During this boxing step, the deformable region 102 can be slightly stretched or on the contrary can be not stretched.

The boxing step is preferably carried out while the container is at a temperature below the glass transition temperature Tg of the polymer constituting the container (cold boxing). Within the scope of the invention, the boxing step can be however also carried out at a temperature above the glass transition temperature Tg (hot boxing step).

Once the deep concave hand grips G are formed in the final container 1′, the air under pressure inside the final container 1 is exhausted in order to release the internal pressure inside the container 1′, the mould cavity is opened, and the final container 1′ is removed from the mould cavity.

As shown on FIGS. 10 and 17, each concave grip G resulting from the inversion of the convex an outwardly protruding deformable portion 102 and of the second lateral wall 1011 of the recess 101 is deep and suitable for ergonomically receiving the fingers or thumb of a hand. Preferably, at least in a portion of the deep grip concave portion G (see FIGS. 10 and 17) the minimum depth DP of the concave grip portion G (FIG. 17) measured in a direction perpendicular to the first central plane P1 is at least 15 mm, and preferably at least 20 mm and/or is more than 50%, and preferably more than 70% of half the aforesaid maximum dimension DR.

In a preferred embodiment, the minimum distance D2 (FIG. 17) between the bottom wall 1021′ of each deep concave portion G and the central plane P1 is preferably not more than 5 mm, and more preferably not more than 2 mm. In another embodiment of the invention (not shown on the appended drawings) the two bottom walls 1021′ of the two concave deep concave portions G can be in contact with each other, and if needed can be welded together or connected by another way

In order to improve the blowing of the intermediate container 1, the depth of the recess 101 is preferably not constant on the whole periphery of the recess. More particularly, as shown on FIGS. 10 and 17, the recess 101 comprises a first portion 101a that is far away from the second vertical central plane P2 and a second portion 101b that is closest to the second vertical central plane P2, and the depth DP1 of said recess 101 measured in said first portion 101a of the recess is smaller than the depth DP2 of said recess 11 measured in said second portion 101b of the recess.

More preferably the depth DP1 of said recess 101 measured in said first portion 101a has to be very small and is preferably not more than 10 mm, more preferably not more than 5 mm and even more preferably between 0 mm and 2 mm. When the second portion 101b of the recess 101 that is closest to the second central plane P2 is offset from this central plane P2, the depth DP2 thereof is preferably not more than 10 mm. In return, when the second portion 101b of the recess 101 that is closest to the second central plane P2 is actually included in this central plane P2, depth DP2 can be more than 10 mm, and the only limitation for depth DP2 is the preform diameter.

Different trials have shown also that, for a better boxing of the intermediate container, the angle α (FIG. 17) between the invertable lateral wall 1020 of the convex and outwardly protruding region 102 and the second plane P2 is preferably not less than 10°. The distance d1 between the first central plane P1 and the bottom of the first portion 101a that is far away from second central plane P2 is also preferably smaller than or equal to the distance d2 between the first central plane P1 and the bottom of the second portion 101b of the recess 101 that is closest to the second central plane P2.

Moreover, for a good stretched blow molding of the intermediate container 1, the angle β between the symmetry plane P3 (FIG. 17) and the first central plane P1 is preferably not more than 15°. In addition, the gripping of the container is improved when the angle α is large and the angle β is small.

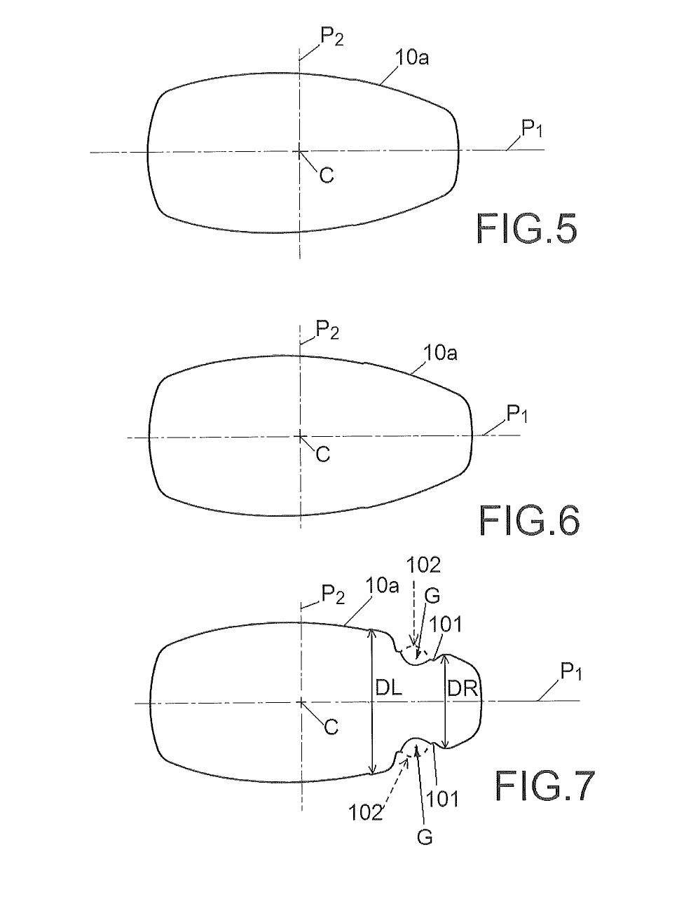

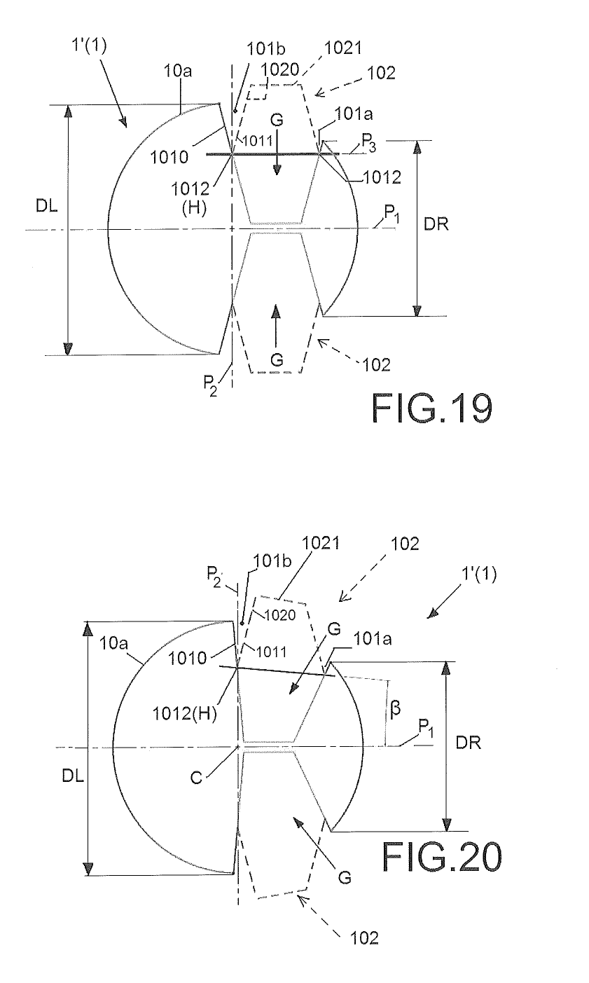

The invention is not limited to the particular design of intermediate container 1 and final container 1′ of FIGS. 1 to 18. FIGS. 19 to 25 shows other examples of horizontal cross section of intermediate container 1 and final container 1′ also covered by the invention. On these FIGS. 19 to 25, the convex outwardly protruding deformable region 102 of the intermediate container is represented in dotted lines. More particularly, the orthogonal projection on the first central plane P1 of each outwardly protruding deformable region 102 is located within the container.

On FIG. 19, the bottom portion 1012 of the second portion 101b of the recess 101 is intersected by the second central plane P2, and the symmetry plane P3 is parallel to first central plane P1 (β=0).

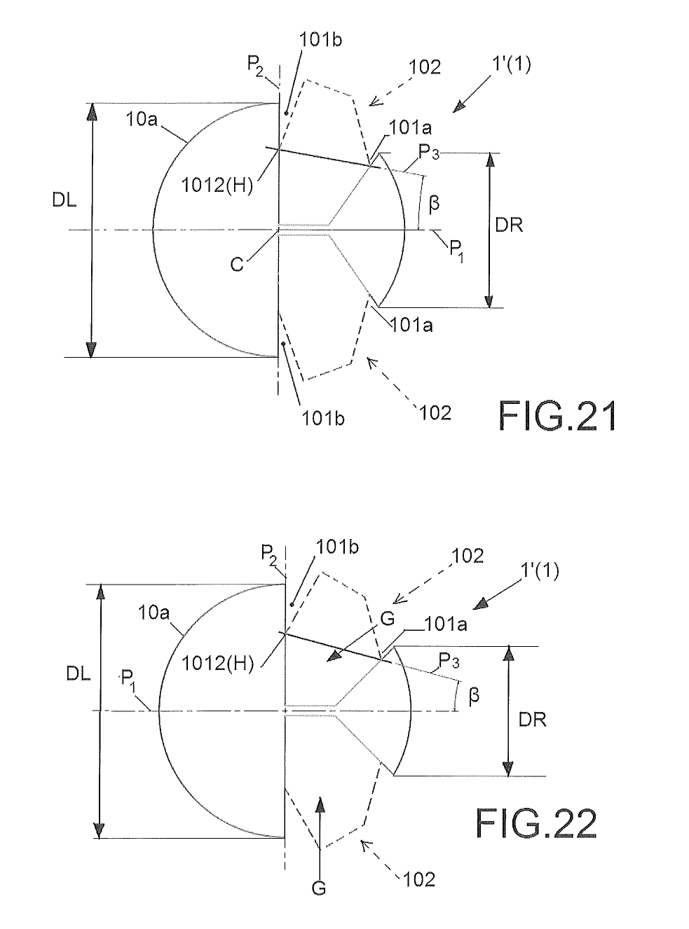

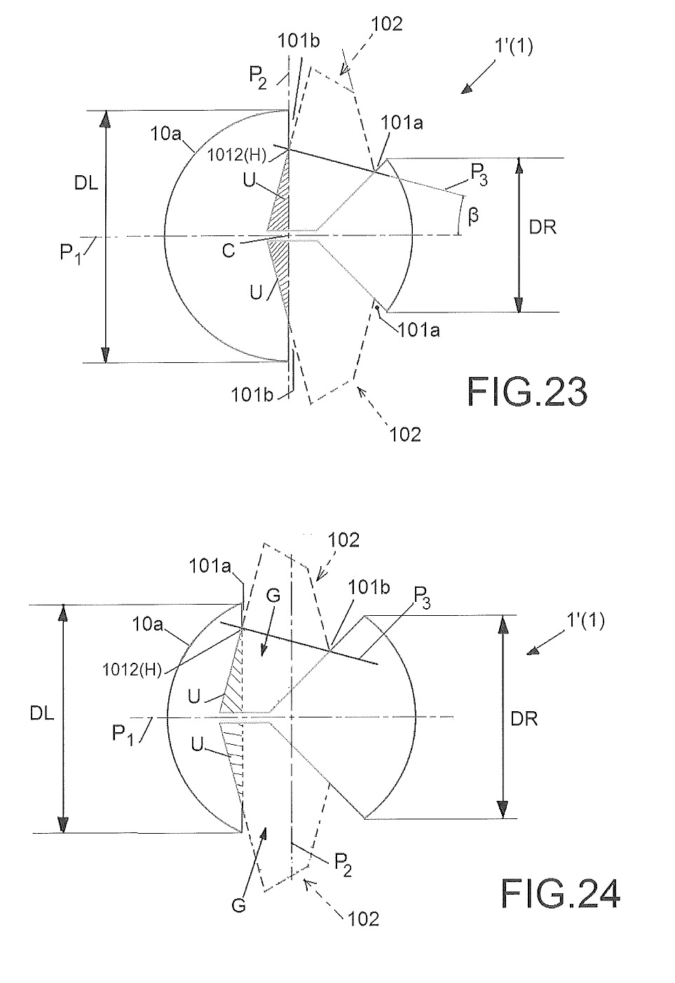

On FIGS. 20 to 23, the bottom portion 1012 of the second portion 101b of the recess 101 is intersected by second plane P2, and the angle β between the symmetry plane P3 and first central plane P1 is about 5° for FIG. 20, about 10° for FIG. 21 and about 15° for FIGS. 2 and 23.

On FIG. 24, the two bottom portions 1012 of the first 101a and second 101b portion of the recess 101 are offset from the second central plane P2 and are positioned respectively on each side of said second central plane.

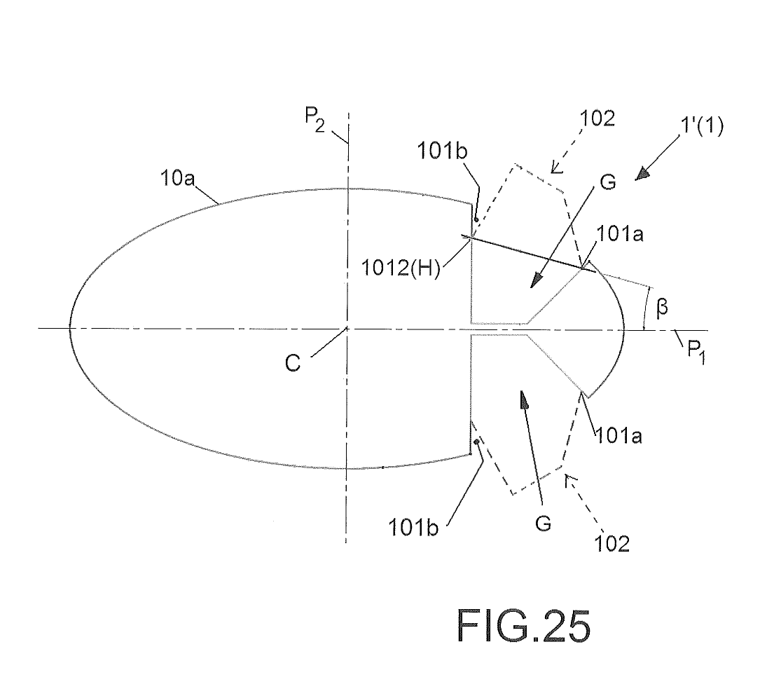

On FIG. 25 the two bottom portions 1012 of the first 101a and second 101b portion of the recess 101 are offset from the second central plane P2 and are positioned on the same side of said second central plane P2.

In the two embodiments of FIGS. 23 and 24, the deep concave grip G of the final container 1 advantageously comprises undercuts regions U (in hatched lines), that is to said regions U that cannot be reached from the outside of the container by a rectilinear axle that is moved in a direction perpendicular to first central plane P1. Usually, the blow molding of such container having undercuts would need the use of a complex blow molding mould having sliding parts for forming the undercut and enabling the removing of the container outside the mould.

More particularly, in the variants of FIGS. 23 and 24, the undercut region U of the deep concave grip G is located on one side of the second vertical central plane P2 and at least a part of the deep concave grip G is located on the other side of the a second vertical central plane P2.

1.-65. (canceled)

66. A process for making a-stretched-blow molded container having at least one deep concave grip, the process comprising:
providing a preform in a mold cavity;
stretch-blow molding the preform to form an intermediate stretched blow-molded container comprising a biaxially stretched-blow molded hollow body having a first vertical central plane and a second vertical central plane perpendicular to the first vertical central plane, the stretched-blow molded hollow body comprising a container side wall and at least one convex and outwardly protruding deformable region that is formed in the container side wall; and
pushing inwardly the at least one convex and outwardly protruding deformable region of the intermediate container towards the first vertical central plane to invert the at least one convex and outwardly protruding deformable region and form in a final container at least one deep concave grip comprising an undercut region that cannot be reached from the outside of the container by a rectilinear axle that is moved in a direction perpendicular to the first central plane.

67. The process of claim 66, wherein the outwardly protruding deformable region that is formed in the container side wall protrudes outwardly in such a way that the orthogonal projection of the outwardly protruding deformable region on the first central plane is located within the container.

68. The process of claim 66, wherein the undercut region of the deep concave grip is located on one side of the second vertical central plane and at least a part of the deep concave grip is located on the other side of the a second vertical central plane.

69. The process of claim 66, wherein the at least one convex and outwardly protruding deformable region is off-center from the second vertical central plane.

70. The process of claim 66, wherein the maximum gripping dimension of the stretched-blow molded hollow body measured next to and on one side of the convex and outwardly protruding deformable region in a gripping region of the container, in a cross section plane that is perpendicular to the first and second central vertical planes and that is intersecting the recess, and in a direction perpendicular to the first vertical plane, is smaller than the maximum dimension of the stretched-blow molded hollow body measured next to and on the other side of the convex and outwardly protruding deformable region in the same cross section plane and direction.

71. The process of claim 66, wherein in the stretch-blow molding step, at least one recess off-center from the second vertical central plane is formed in the container side wall, wherein the recess comprises a first lateral wall, a second lateral wall opposite the first lateral wall, and a bottom portion joining the first lateral wall to the second lateral wall, wherein the convex and outwardly protruding deformable region comprises an outwardly protruding invertable lateral wall, that is an extension of the second lateral wall of the recess at least on a portion of the periphery of the convex and outwardly protruding deformable region, and that extends beyond the first lateral wall of the recess, and a front wall that is an extension of this outwardly protruding invertable lateral wall, wherein at least a junction between the bottom portion and the second lateral wall of the recess forms an hinge on the periphery of the outwardly protruding convex deformable region for inverting the outwardly protruding convex deformable region and the second lateral wall of the recess by pushing them inwardly to form the concave deep grip.

72. The process of claim 71, wherein the recess defines a closed contour and the convex and outwardly protruding deformable region is surrounded by the recess.

73. The process of claim 71, wherein the depth of the recess is not the same on the whole periphery of the recess.

74. The process of claim 71, wherein the off-center recess comprises a first portion that is far away from the second vertical central plane, and a second portion that is closest to the second vertical central plane or is intersected by the second vertical central plane, and wherein the depth of the recess measured in the first portion of the recess is smaller than the depth of the recess measured in the second portion of the recess.

75. The process of claim 71, wherein the off-center recess comprises a first portion that is far away from the second vertical central plane, and a second portion that is intersected by the second vertical central plane.

76. The process of claim 71, wherein all the recess is off-center from the second central plane.

77. The process of claim 71, wherein the off-center recess comprises a first portion that is far away from the second vertical central plane and a second portion that is closest to the second vertical central plane or is intersected by the second vertical central plane, and wherein the distance between the bottom of the first portion of the recess and the first central plane is smaller than or equal to the distance between the bottom of the second portion of the recess and the first central plane.

78. The process of claim 71, wherein in the stretch-blow molding step, two opposite convex and outwardly protruding deformable regions are formed.

79. The process of claim 78, wherein each of the opposite convex and outwardly protruding deformable regions is surrounded by a recess.

80. A stretched-blow molded container made by the process of claim 66.

81. The stretched-blow molded container of claim 80, wherein the outwardly protruding deformable region that is formed in the container side wall protrudes outwardly in such a way that the orthogonal projection of the outwardly protruding deformable region on the first central plane is located within the container.

82. The stretched-blow molded container of claim 80, wherein the undercut region of the deep concave grip is located on one side of the second vertical central plane and at least a part of the deep concave grip is located on the other side of the a second vertical central plane.

83. The stretched-blow molded container of claim 80, wherein the at least one convex and outwardly protruding deformable region is off-center from the second vertical central plane.

84. The stretched-blow molded container of claim 80, wherein the maximum gripping dimension of the stretched-blow molded hollow body measured next to and on one side of the convex and outwardly protruding deformable region in a gripping region of the container, in a cross section plane that is perpendicular to the first and second central vertical planes and that is intersecting the recess, and in a direction perpendicular to the first vertical plane, is smaller than the maximum dimension of the stretched-blow molded hollow body measured next to and on the other side of the convex and outwardly protruding deformable region in the same cross section plane and direction.

85. A stretched-blow molded container made by the process of claim 71.
